(19) United States
(12) Patent Application Publication
(10) Pub. No.: US 2026/0079483 A1
(43) Pub. Date: Mar. 19, 2026

(54) Method and Device for Measuring a Technical System on a Test Bench Using Safe Active Learning

(71) Applicant: Robert Bosch GmbH, Stuttgart (DE)

(72) Inventors: Matthias Kraenzler, Dettingen An Der Erms (DE); Timo Bartsch, Heimsheim (DE); Volker Imhof, Kornwestheim (DE); Christoph Zimmer, Stuttgart (DE); Daniel Neyer, Stuttgart (DE); Wael Hilali, Stuttgart (DE); Tabea Schlagmueller, Schwieberdingen (DE); Tobias Pinkau, Eberdingen (DE)

(21) Appl. No.: 19/332,691

(22) Filed: Sep. 18, 2025

(30) Foreign Application Priority Data
Sep. 19, 2024 (DE) 10 2024 208 983.4

(51) Int. Cl. G05B 23/02

(52) U.S. Cl. CPC G05B 23/024

(57) ABSTRACT

A computer-implemented method for providing input data points for measuring a technical system is disclosed. The technical system is measured in particular on a test bench according to predefined measurement trajectories in order to obtain measurement data, wherein the measurement data assigns one or more measured variables as labels to an input data point from one or more input variables. The method includes (i) measuring a measurement trajectory by successively controlling the technical system with input data points of the measurement trajectory and identifying the respective one or more measured variables as respective labels, (ii) training or updating a data-based surrogate model, which is designed in particular as a probabilistic regression model, with the labeled input data points, (iii) determining a further measurement trajectory to be measured by optimizing a total information measure of the input data points of the measurement trajectory in the surrogate model, and (iv) measuring the technical system with the determined further measurement trajectory to be measured. The total information measure indicates a sum of the information measures of the individual input data points of the measurement trajectory, wherein the information measure specifies the contribution of the relevant input data point to the further training of the surrogate model.

This application claims priority under 35 U.S. C. § 119 to application no. DE 10 2024 208 983.4, filed on Sep. 19, 2024 in Germany, the disclosure of which is incorporated herein by reference in its entirety.

The disclosure relates to methods for measuring a technical system on a test bench to determine training data for the purpose of model generation or to generate a sensor model for a virtual sensor. The disclosure also relates to the provision of measurement trajectories for measuring the technical system on a test bench while avoiding undesirable or critical operating points.

### BACKGROUND

Technical systems are often operated using control units in which a microcontroller executes an algorithm implemented in hardware and/or software in the form of a computational model. Models suitable for technical systems are often created, which can be implemented, for example, as virtual sensors or for monitoring in the form of a digital twin.

Due to the complexity of the physical system, these models are often difficult to model physically, and therefore data-based models (machine learning models) trained as computational models are provided, which map or take into account the real physical behavior of the system. These calculation models can be evaluated at each queried evaluation data point in order to determine control variables directly or indirectly. Such data-based models may include, for example, RBF networks, artificial neural networks, Gaussian process models, and the like.

To create such a data-based model, measurement data is required, which is usually determined on a test bench. These measurement data serve as the basis for creating training data sets that represent pairs of input data points from one or more input variables and/or state variables and output values. Together, these define the desired model context that is to be mapped by the data-based model after training. For example, technical systems can be operated on a test bench with trajectories of input data points, and a resulting variable can be identified as a label, so that the training data sets are derived from the input data points of the trajectory and the resulting variable identified as a label.

The limited availability and high requirements for the quality of the measurement data lead to long measurement campaigns and thus to high application costs. The preparation of measurement data for performing a test bench measurement usually requires lengthy planning and continuous monitoring of the technical system to be measured in order to avoid exceeding known safety limits.

The measurement trajectories from the test bench measurement are decisive for creating the training data required for training the data-based model. The quality and quantity of training data are crucial for the performance of the data-based model trained with it. An important aspect in generating the measurement trajectories is the complete coverage of the input data space in order to avoid so-called white spots, which significantly influence the behavior of the data-based model in unknown areas. Complete coverage of the data space, i.e., the measurement data to be measured, leads to extrapolation behavior of the data-based model during model evaluation with a high degree of uncertainty. Previous approaches specify the measurement trajectories to be measured and monitor the technical system with regard to certain state variables in order to detect limit value exceedances and, if necessary, stop the measurement to prevent damage to the technical system.

### SUMMARY

According to the disclosure, a method for determining training data by measuring a technical system on a test bench using an active learning method, as well as a corresponding device and a test bench are provided.

Further embodiments are also provided.

According to one aspect, a computer-implemented method is provided for supplying input data points for measuring a technical system, wherein the technical system is measured in particular on a test bench according to predefined measurement trajectories in order to obtain measurement data, wherein the measurement data assigns one or more measured variables as labels to an input data point from one or more input variables, comprising the following steps:
measuring a measurement trajectory by successively controlling the technical system with input data points of the measurement trajectory and identification of the respective one or more measured variables as respective labels;
training or updating a data-based surrogate model, which is specifically designed as a probabilistic regression model, with the labeled input data points;
determining a further measurement trajectory to be measured by optimizing a total information measure of the input data points of the measurement trajectory in the surrogate model;
measurement of the technical system with the determined further measurement trajectory to be measured,
   wherein the total information measure indicates a sum of the information measures of the individual input data points of the measurement trajectory, wherein the information measure specifies the contribution of the relevant input data point to the further training of the surrogate model.

As described at the outset, the data-based model to be created can be used in the control of technical systems, such as the control of electric machines, combustion engines, and the like, to support a control system, e.g., through application in an observer, as a virtual sensor, e.g., as a speed sensor, as a temperature sensor, and the like. Basically, the data-based model serves to provide a functional connection that is crucial for the operation of technical systems.

To create a data-based model that will later be used as a virtual sensor or as a system model in the form of a digital twin, measurements must be taken on a test bench to specify the system behavior at many operating points. Particularly in dynamic systems, such measurement is performed by traversing a plurality of measurement trajectories of input data points and measuring state variables assigned to the corresponding input data points and their development. The measurement trajectories correspond to a sequence of predefined input data points that are applied to the technical system during the measurement process. The data sets obtained in this way from input data points and respective state variables as system responses form the training data sets that can be used to train the data-based model.

In order to achieve good model quality, it is necessary for the space of the input data points to be as large as possible, wherein during measurement on the test bench it must be ensured that no impermissible operating points are approached which could damage or destroy the technical system, for example if the temperature in a component of the technical system exceeds a permissible limit temperature.

It may be provided that the measuring, training, and determining of the further measurement trajectory to be measured is performed repeatedly until a predefined number of labeled input data points is available.

In accordance with the above method, an active learning method is carried out in which, based on a measurement of a measurement trajectory, a surrogate model that maps the behavior of the technical system is created or further developed, and then, according to a total information measure, a measurement trajectory is specified with which the next measurement is to be carried out. The measurement with the measurement trajectory results in an assignment of input data points and a corresponding measured variable that is assigned to the respective input data point.

The information measure may correspond to or depend on entropy or predictive variance or a minimum-value logarithm of the determinant of the covariance matrix of the input data point.

The total information measure can be maximized using an optimization problem, wherein the information measure can be entropy. If the surrogate model is designed as a probabilistic regression model, such as a Gaussian process model, the predictive variance can be assumed as an information criterion.

To specify the total information measure for a measurement trajectory with a large number of input data points, it can be discretized, for example based on the measurement frequency, and the total information measure can be calculated as the sum of the information measures at the corresponding input data points, i.e. Trajectory points at which model evaluation and measurement take place are specified. The information measure can be specified as entropy or predictive variance.

Furthermore, training and determining the further measurement trajectory to be measured can be carried out at least partially in parallel with a measurement process.

The measurement should be performed asynchronously in order to determine the further training of the surrogate model and the determination of the next measurement trajectory using the optimization method during the measurement of a measurement trajectory.

In the conventional, obvious operating mode, a measurement trajectory is measured. The measurement results of this survey are taken into account in the further training, i.e., retraining, of the surrogate model, and the next measurement trajectory is specified by the optimization method. Conventionally, no determination takes place during the determination of the next measurement trajectory. This results in waiting times, during which an indefinite change in the state of the technical system (such as the temperature) may occur, thus defining an indefinite starting point for the next measurement trajectory. For example, when measuring the temperature of a component of a technical system, the temperature may change during the waiting time until the next measurement is started.

In asynchronous mode, two predefined measurement trajectories can initially be measured one after the other, and during or after the measurement of the last measurement trajectory, the surrogate model can be further trained with the measurement data from the measurement of the first measurement trajectory. After updating the surrogate model, the optimization method can be used to specify the next measurement trajectory to be measured.

This is now used for measurement, and at the same time, based on the measurement data from the last measured measurement trajectory, the surrogate model is further developed in order to specify a subsequent measurement trajectory to be measured. This allows the continuous further training of the surrogate model during the measurement of a measurement trajectory and the next measurement trajectory to be specified using the optimization method.

A PT1 NARX-GP can be used for the surrogate model, which smooths the input data points with a low-pass filter and uses the historical data of the input data points by way of a NARX structure. This is transferred in a sparse Gaussian process model as a surrogate model. Based on this surrogate model, the next measurement trajectory that provides the greatest information content (greatest total information measure) for the further training of the data-based model is specified. Since the prediction of the data-based model for a measurement trajectory yields not only a mean value but also a variance, the measurement trajectory with the largest variance or the minimum-value logarithm of the determinant of the covariance matrix is used.

The measurement trajectory to be measured next can be determined by checking one or more auxiliary conditions.

An auxiliary condition can be a restriction of the space of the input data points, in which the individual input variables of the input data points are described with minimum and maximum limits in order to describe a hyperbox.

Furthermore, nonlinear auxiliary conditions of the form C(x)<0 (x corresponds to the input data point) can also be defined, which can be used to define nonlinear limitations of the input data space.

After surveying with measurement trajectories, the input data space can also be described using a point cloud of all measurement data points. These are known as valid or invalid input data points based on corresponding criteria. If only input data points within the valid range are known, a single-class classifier (single-class classification model) can be trained so that no invalid areas arise within the point cloud and the single-class classifier quickly outputs a value defined as invalid at the edge of the point cloud. This means that each input data point of an input data trajectory can be checked using the single-class classifier. The single-class classification model can be designed based on data in the form of a neural network, a nearest neighbor classifier, or similar.

If the space of the already measured input data points can be divided into valid and invalid measurement points, a two-class classification model can be created. This has the advantage that the boundary between valid and invalid input data points can be described with particular precision. Here, a sparse Gaussian process model can be used as a classification model.

Furthermore, variable auxiliary conditions can be defined that can be learned continuously. These may stipulate, for example, that the exploration of the input data space should not be carried out too quickly, as the variable auxiliary conditions are very uncertain. The validity of an input data point can then be specified by calculating the variance of the surrogate model at this input data point and checking it against a threshold value that represents the criterion for the auxiliary conditions. The threshold value can represent the maximum variance of all input data points, so that at least all input data points are within the valid range and at least one input data point is directly at the edge of the input data space of the surrogate model.

Another auxiliary condition can be specified by describing the range of the input data points measured so far using a kernel function model, in which a Gaussian kernel is calculated at each input data point of the measurement trajectories. An unknown input data point of a measurement trajectory to be newly measured is valid if the output value of the corresponding Gaussian kernel is greater than a predefined threshold value. It may be stipulated that a new measurement trajectory is accepted if the output values of all corresponding Gaussian kernels for the input data points meet the threshold value. In addition, a further auxiliary condition can be implemented directly on the prediction of the surrogate model using a threshold. The measured variable to be modeled should not exceed a specified threshold value.

For the surrogate model, a probabilistic regression model can be trained, e.g., in the form of a Gaussian process model. This means that not only is the mean value forecast of the parameters of the next proposed measurement trajectory known, but also their variance. A measurement trajectory determined by the optimization method is only valid, for example, if its input data points plus the respective variance, weighted with a weighting factor if necessary, remain below the predefined threshold value. This has the advantage that, in the case of a model that is still inaccurate, the measurement trajectories are removed from the boundary areas of the safe/valid input data space, and only later, when the safe/valid input data space has been well mapped, are input data points from measurement trajectories used that are closer to the boundary.

### BRIEF DESCRIPTION OF THE DRAWINGS

Preferred embodiments are described in more detail below with reference to the accompanying drawings. The figures show:

FIG. 1 a schematic representation of a technical system with a control unit in which a data-based model is implemented.

FIG. 2 a schematic representation of a test bench with an electric machine as an example of a technical system; and

FIG. 3 a flowchart illustrating a method for performing a test bench measurement for the electric machine to determine training data points for training a data-based model for the control unit of FIG. 1.

### DETAILED DESCRIPTION

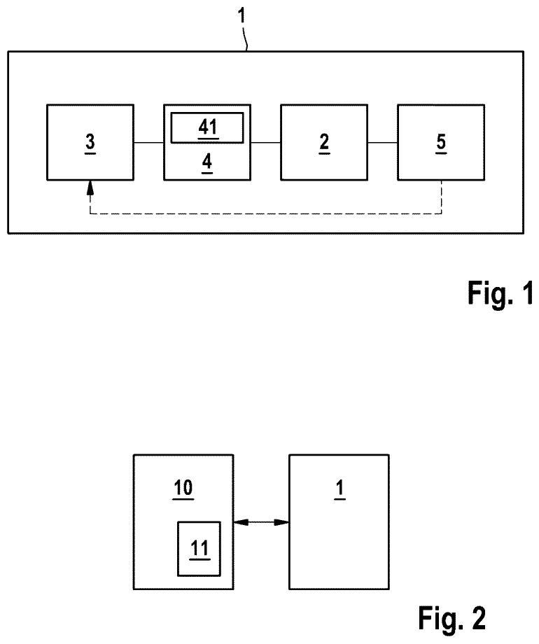

FIG. 1 schematically shows a technical system 1 with an actuator 2 in the form of one or more actuators, for example, electromechanical actuators and the like. Actuator 2 acts on a technical device 5 and thereby controls it directly, e.g. mechanically. Furthermore, a sensor system 3 is provided to identify state variables of the technical device 5 and to transmit the corresponding state variables to a control unit 4.

The technical system 1 can be, for example, a machine tool, a robotics application, a motor vehicle, or the like, in which, for example, electromechanical actuators are provided that perform a movement depending on state variables of the system 1. Furthermore, technical system 1 can comprise a virtual sensor, e.g., for determining the temperature depending on other operating variables (which define the input data point), in order to control processes based on a temperature specified in this way or to implement an overtemperature shutdown.

The control unit 4 comprises a data-based functional model 41 which, during operation of the technical system 1, evaluates a predefined evaluation point and provides a corresponding model output. The model output can, for example, represent a value of a virtual sensor implemented with the function model 41 and/or be used directly or indirectly to control the actuator 2. The evaluation point can be formed, for example, from one or more reference variables, e.g., provided externally or from a process control, and/or one or more state variables, e.g., recorded by sensors.

The functional model 41 may be designed as a neural network, RBF network, or the like, and may be trained using training data sets corresponding to labeled input data points.

The data-based functional model 41 must be trained with training data sets prior to commissioning so that a corresponding function of the control unit 4 can be implemented. For this purpose, System 1 can be measured on a test bench in a manner known per se, and labels for input data points of the measurement can be determined directly or indirectly. The training data sets are derived from the input data points and, if applicable, one or more reference variables, and are assigned to an output variable as a control variable for, e.g., an actuator. The input data points can result from a direct reference to one or more static control variables and/or one or more corresponding trajectories and/or one or more resulting state variables that can be determined by sensors at the time of control.

FIG. 2 shows a test bench 10 for the technical system 1, which can be designed, for example, as a motor system with an electric machine. Test bench 10 comprises a control unit 11 that is suitable for controlling the technical system 1 in an appropriate manner.

Furthermore, the electric machine is equipped with at least one temperature sensor to identify the temperature of a specified component. The electric machine is operated by predefining a supply voltage, by predefining a control torque, by predefining a speed, by predefining a coolant temperature, and the like. These input variables (reference variables) can be set or predefined externally and form an input data point. In order to map the dynamic behavior of the electric machine during the formation of temperature in the component, such as the stator of the electric machine, measurement trajectories are used to measure a time sequence of input data points along a curve. The input data points can be applied to the technical system 1 of the electric machine according to a predefined constant or variable sampling rate, and the corresponding temperature of the component can be measured.

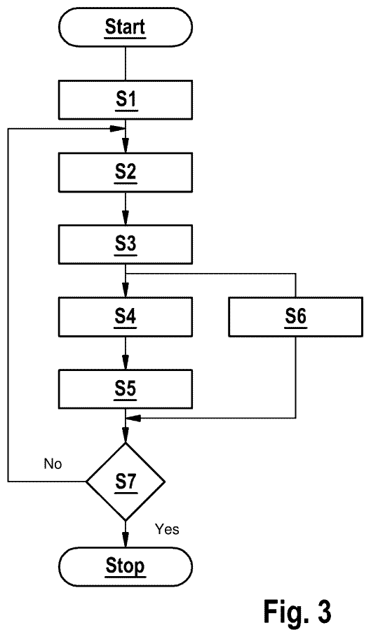

The measurement is performed automatically based on the flowchart described in more detail in FIG. 3.

In step S1, an initial surrogate model is provided for this purpose, which corresponds to the data-based model in which the input variables are designed as input data points for outputting the measured variable, in particular the temperature of the component.

An information measure can be determined from the surrogate model, which can correspond, for example, to entropy or the predictive variant, in order to use it in an active learning method.

In step S2, a first measurement trajectory and a second measurement trajectory are first specified or predefined for the two measurement trajectories to be measured next.

Then, in step S3, the measurement is started with the first measurement trajectory or performed with the last measurement trajectory determined. The first measurement trajectory has a number of input data points that are applied to the electric machine in sequence according to the sampling rate. At the same time, the resulting temperatures are measured as measurement data and assigned to the respective input data point as a label.

In step S4, the measurement data is used to further train or update the surrogate model.

In step S5, an optimization is performed to specify the next measurement trajectory for surveying. The measurement trajectory is specified as a parameter, e.g., as one or more connected straight lines, curves, or similar.

Optimization is achieved by maximizing the total information measure, which indicates the information gain for the surrogate model when using the corresponding measurement trajectory for surveying.

The total information measure can correspond to the sum of the entropies or predictive variances of the individual input data points on the corresponding measurement trajectory.

Regardless of the length of the measurement trajectory, the number of sampling points along the specified measurement trajectory can be normalized.

Simultaneously with the further training of the surrogate model and the specification of the next measurement trajectory in steps S4 and S5, the measurement is carried out in step S6 using the last determined measurement trajectory.

Then, in step S7, a termination condition is checked. For example, it is checked whether the number of measured input data points and/or the number of measured measurement trajectories is sufficient. If the method is to be terminated (alternative: No), proceed to step S2. Otherwise (alternative: Yes), the method is terminated.

The process can be repeated on these, wherein the most recently determined measurement trajectory is measured and the results of the previous measurement of a measurement trajectory are used to update the surrogate model and specify the next measurement trajectory. This allows the method to be performed iteratively in order to measure the input data space of all input data points.

Performing the method so that the calculation of the further training of the surrogate model and the calculation of the information measure take place in parallel with the measurement of a measurement trajectory enables the best possible use of the test bench and prevents undesirable changes in the state of the electric machine, such as cooling, from occurring between measurements with the measurement trajectories.

Auxiliary conditions are taken into account when determining the next measurement trajectory. The auxiliary conditions may include one or more of the following auxiliary conditions:
all input data points lie within a predefined hyperbox;
none of the input data points exceed a defined linear or nonlinear limit of the input data space;
a classification result of a classification model depending on each of the input data points is above a threshold value;
the variance of the surrogate model at each of the input data points is less than the maximum variance of all input data points.
the output values of the surrogate model for all input data points are greater than a predefined threshold value; and
the output values of the surrogate model for all input data points plus their weighted variance in particular is less than a predefined threshold value.

What is claimed is:

1. A computer-implemented method for providing input data points for measuring a technical system, wherein the technical system is measured on a test bench according to predefined measurement trajectories in order to obtain measurement data, and wherein the measurement data assigns one or more measured variables as labels to an input data point from one or more input variables, the computer-implemented method comprising:
measuring a measurement trajectory by successively controlling the technical system with input data points of the measurement trajectory and identifying the respective one or more measured variables as respective labels;
training or updating a data-based surrogate model which is designed as a probabilistic regression model with the labeled input data points;
determining a further measurement trajectory to be measured by optimizing a total information measure of the input data points of the measurement trajectory in the surrogate model; and
measuring the technical system with the determined further measurement trajectory to be measured,
wherein the total information measure indicates a sum of the information measures of the individual input data points of the measurement trajectory, and
wherein the information measure specifies the contribution of the respective input data point to the further training of the surrogate model.

2. The method according to claim 1, wherein the information measure corresponds to or depends on an entropy or a predictive variance or a minimum-value logarithm of the determinant of the covariance matrix of the input data point.

3. The method according to claim 1, wherein the measuring, training, and determining of the further measurement trajectory to be measured are performed repeatedly until a predefined number of labeled input data points is available.

4. The method according to claim 3, wherein the training and the determination of the further measurement trajectory to be measured are performed at least partially in parallel or simultaneously with a measurement process.

5. The method according to claim 1, wherein the optimization is performed based on one or more auxiliary conditions which comprise at least one of the following:
all input data points lie within a predefined hyperbox;
none of the input data points exceed a defined linear or nonlinear limit of the input data space;
a classification result of a classification model depending on each of the input data points is above a threshold value;
the variance of the surrogate model at each of the input data points is less than the maximum variance of all input data points;
the output values of the surrogate model for all input data points are greater than a predefined threshold value; and
the output values of the surrogate model for all input data points plus their weighted variance is less than a predefined threshold value.

6. The method according to claim 1, wherein the surrogate model corresponds to a PT1 NARX Gaussian process model.

7. The method according to claim 1, wherein the technical system is trained based on the determined labeled input data points.

8. A device for carrying out the method according to claim 1.

9. A computer program product comprising instructions which, when executed by at least one data processing device, cause the device to perform the steps of the method according to claim 1.

10. A machine-readable storage medium comprising instructions which, when executed by at least one data processing device, cause the device to perform the steps of the method according to claim 1.
